(19) United States
(12) Patent Application Publication
(10) Pub. No.: US 2024/0429798 A1
(43) Pub. Date: Dec. 26, 2024

(54) METHOD FOR MANUFACTURING ROTOR

(71) Applicant: TOYOTA BOSHOKU KABUSHIKI KAISHA, Aichi-ken (JP)

(72) Inventor: Takeshi NOMURA, Chiryu-shi (JP)

(73) Assignee: TOYOTA BOSHOKU KABUSHIKI KAISHA, Aichi-ken (JP)

(21) Appl. No.: 18/745,173

(22) Filed: Jun. 17, 2024

(30) Foreign Application Priority Data
Jun. 26, 2023 (JP) 2023-104352

(51) Int. Cl. H02K 15/12; H02K 1/276; H02K 1/28; H02K 15/03

(52) U.S. Cl. CPC H02K 15/12; H02K 1/276; H02K 1/28; H02K 15/03

(57) ABSTRACT

In a method for manufacturing a rotor, when “Lm” represents a length of a magnet in an axial direction before a resin material is injected into a magnet housing hole, “Lr” represents a length of a closing portion in the axial direction when the magnet is heated by the resin material in the magnet housing hole and shortened, “α” represents a negative coefficient of linear expansion of the magnet in the axial direction, “β” represents a contraction rate of the resin material, and “ΔT” represents a difference between a temperature of the magnet that is heated by the resin material in the magnet housing hole and shortened and a temperature of the magnet when the resin material is cooled and solidified, the length Lm of the magnet and the length Lr of the closing portion are set to satisfy an inequality Lm·α·ΔT≥(Lr·β)/2.

### CROSS-REFERENCE TO RELATED APPLICATIONS

This application is based upon and claims the benefit of priority from prior Japanese Patent Application No. 2023-104352, filed on Jun. 26, 2023, the entire contents of which are incorporated herein by reference.

### BACKGROUND

### 1. Field

The following description relates to a method for manufacturing a rotor.

### 2. Description of Related Art

A rotating electric machine includes a cylindrical stator and a rotor that is rotated at the inner side of the stator.

Japanese Laid-Open Patent Publication No. 2016-119766 discloses a rotor for a magnet-embedded rotating electric machine. The rotor includes a cylindrical rotor core including magnet housing holes, magnets accommodated in the magnet housing holes, and a thermoplastic resin material that fills the magnet housing holes and fixes the magnets to the rotor core.

Each magnet has a length in the axial direction (hereinafter, simply referred to as the length of the magnet) that is less than the length of the rotor core in the axial direction. The resin material has a closing portion that covers one end surface of the magnet in a lengthwise direction of the magnet and closes the opening of the magnet housing hole.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some rotors use a neodymium magnet as the magnet. The neodymium magnet has a positive coefficient of linear expansion in a magnetization direction, and has a negative coefficient of linear expansion in a non-magnetization direction orthogonal to the magnetization direction. Thus, when the lengthwise direction of the magnet coincides with the non-magnetization direction, the heat of the resin material arranged in the magnet housing hole increases the temperature of the magnet and decreases the length of the magnet. Further, a decrease in the temperature of the resin material decreases the temperature of the magnet and increases the length of the magnet.

When the resin material is cooled, the resin material solidifies inside the magnet housing hole. In this case, the resin material contracts such that the length of the closing portion in the axial direction (hereinafter, simply referred to as the length of the closing portion) is decreased.

Therefore, when the resin material is cooled, the length of the closing portion decreases and the length of the magnet increases. Accordingly, if the closing portion is deformed in the axial direction by a greater amount than the magnet, a gap may be formed between the magnet and the closing portion. Such a gap may trap heat and increase the temperature of the magnet when the rotor is in use. This may cause reduction in the magnetic strength of the magnet and adversely affect the performance of the rotor.

In one general aspect, a method for manufacturing a rotor is provided. The rotor includes a cylindrical rotor core that includes a magnet housing hole, a magnet accommodated in the magnet housing hole, and a thermoplastic resin material that fills the magnet housing hole and fixes the magnet to the rotor core. The magnet has a negative coefficient of linear expansion in a non-magnetization direction orthogonal to a magnetization direction. The magnet is oriented and accommodated in the magnet housing hole such that the non-magnetization direction coincides with an axial direction of the rotor core. The resin material includes a closing portion that covers one end surface of the magnet in the axial direction inside the magnet housing hole and closes an opening of the magnet housing hole. The method includes holding the rotor core from opposite sides in the axial direction with a die in a state in which the die supports an other end surface of the magnet accommodated in the magnet housing hole. The other end surface is opposite to the one end surface. The die is configured to inject the resin material into the magnet housing hole. The method further includes fixing the magnet to the rotor core by filling the magnet housing hole, in which the magnet is accommodated, with the resin material that is melted and solidifying the molten resin material. When a length of the magnet in the axial direction before the resin material is injected into the magnet housing hole is represented by Lm, a length of the closing portion in the axial direction when the magnet is heated by the resin material arranged in the magnet housing hole and the length of the magnet is decreased is represented by Lr, the negative coefficient of linear expansion of the magnet in the axial direction is represented by a, a contraction rate of the resin material is represented by β, and a difference between a temperature of the magnet when the magnet is heated by the resin material arranged in the magnet housing hole and the length of the magnet is decreased and a temperature of the magnet when the resin material is cooled and solidified is represented by ΔT, the length Lm of the magnet and the length Lr of the closing portion are set to satisfy an inequality Lm·α·ΔT≥(Lr·β)/2.

Other features and aspects will be apparent from the following detailed description, the drawings, and the claims.

### BRIEF DESCRIPTION OF THE DRAWINGS

FIG. 1 is a plan view of a rotor manufactured by a manufacturing method in accordance with an embodiment.

FIG. 2 is a cross-sectional view of the rotor shown in FIG. 1.

FIG. 3 is a cross-sectional view of a mold device for manufacturing the rotor shown in FIG. 1.

FIG. 4 is a cross-sectional view showing a state immediately after a magnet housing hole of a rotor core is filled with a resin material.

FIG. 5 is a cross-sectional view showing a state in which a length of a magnet is decreased when the magnet is heated.

FIG. 6 is a cross-sectional view showing a state in which the length of the magnet is increased when the magnet is cooled.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

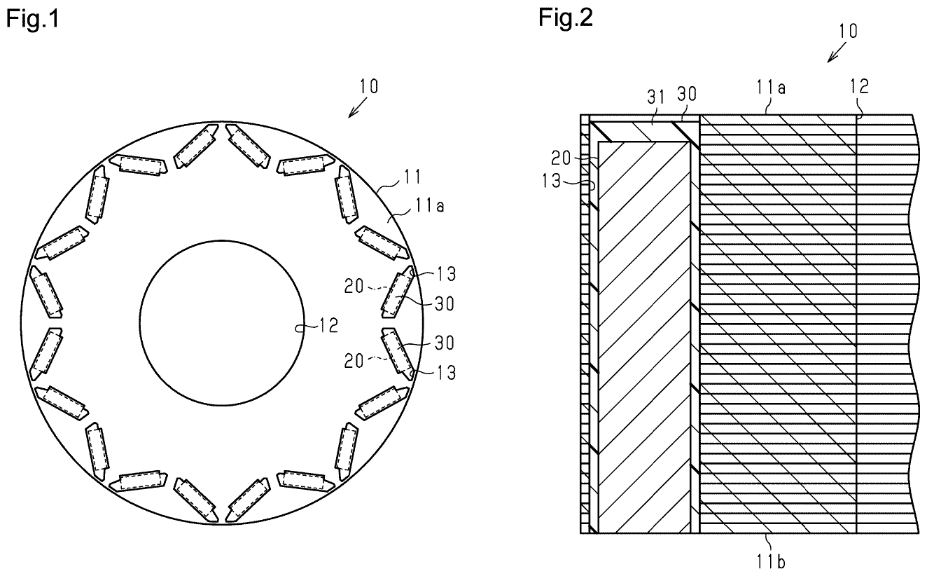

An embodiment of a method for manufacturing a rotor will now be described with reference to FIGS. 1 to 6.

### Rotor 10

As shown in FIG. 1, a rotor 10 includes a rotor core 11, magnets 20, and a resin material 30. For example, the rotor 10 is for a magnet-embedded motor.

### Rotor Core 11

The rotor core 11 is substantially cylindrical.

Hereinafter, an axial direction of the rotor core 11 will simply be referred to as the axial direction. A radial direction of the rotor core 11 will simply be referred to as the radial direction. A circumferential direction of the rotor core 11 will simply be referred to as the circumferential direction.

As shown in FIG. 2, the rotor core 11 is formed, for example, by stacking iron core pieces that are punched out from an electromagnetic steel sheet.

The rotor core 11 includes a first end face 11a and a second end face 11b that are located at opposite sides in the axial direction.

The rotor core 11 includes a center hole 12 and magnet housing holes 13. A shaft (not shown) is inserted into the center hole 12. Magnets 20 are accommodated in the magnet housing holes 13. The magnet housing holes 13 are arranged at intervals in the circumferential direction.

The center hole 12 and the magnet housing holes 13 extend through the rotor core 11 in the axial direction. In other words, the center hole 12 and the magnet housing holes 13 are open in the first end face 11a and the second end face 11b.

As shown in FIG. 1, each magnet housing hole 13 has a substantially rectangular cross-sectional shape that is orthogonal to the axial direction. The rectangular cross-sectional shape has the long side and the short side. The cross-sectional shape of the magnet housing hole 13 is the same throughout the axial direction.

### Magnet 20

Each magnet 20 is accommodated in a corresponding magnet housing hole 13. The magnet 20 is fixed to the rotor core 11 by the resin material 30 arranged in the magnet housing hole 13.

As shown in FIG. 2, each magnet 20 is long in the axial direction. The magnet 20 is shorter than the rotor core 11 in the axial direction.

The magnet 20 includes one end surface in the axial direction. For example, the one end surface is located at an inner side of the first end face 11a in the axial direction. The magnet 20 includes another end surface opposite to the one end surface in the axial direction. For example, the other end surface is flush with the second end face 11b.

Each magnet 20 has a substantially rectangular cross section that is orthogonal to the axial direction. The rectangular cross-sectional shape has the long side and the short side. The drawings show cross-sectional shapes of the magnet 20 taken along the long side of the magnet 20.

The magnet 20 is, for example, a neodymium magnet. The magnet 20 has a positive coefficient of linear expansion in a magnetization direction, and has a negative coefficient of linear expansion in a non-magnetization direction orthogonal to the magnetization direction. The short-side direction of the magnet 20 is the magnetization direction. The long-side direction and the lengthwise direction of the magnet 20 are the non-magnetization directions. Thus, each magnet 20 is oriented and accommodated in a corresponding magnet housing hole 13 such that the non-magnetization direction coincides with the axial direction of the rotor core 11 and the magnetization direction coincides with the short-side direction of the magnet housing hole 13.

### Resin Material 30

The resin material 30 is, for example, arranged between inner walls of the magnet housing hole 13 and outer surfaces of the magnet 20 along an entire circumference of the magnet 20.

The resin material 30 includes a closing portion 31 that covers the one end surface of the magnet 20 in the axial direction inside the magnet housing hole 13 and closes the opening of the magnet housing hole 13. The closing portion 31 is located at an inner side of the first end face 11a of the rotor core 11 in the axial direction.

The resin material 30 is, for example, a thermoplastic resin such as a liquid crystal polymer.

### Mold Device 40

A mold device 40 configured to fill the magnet housing holes 13 with the resin material 30 will now be described. The mold device 40 is an example of a mold.

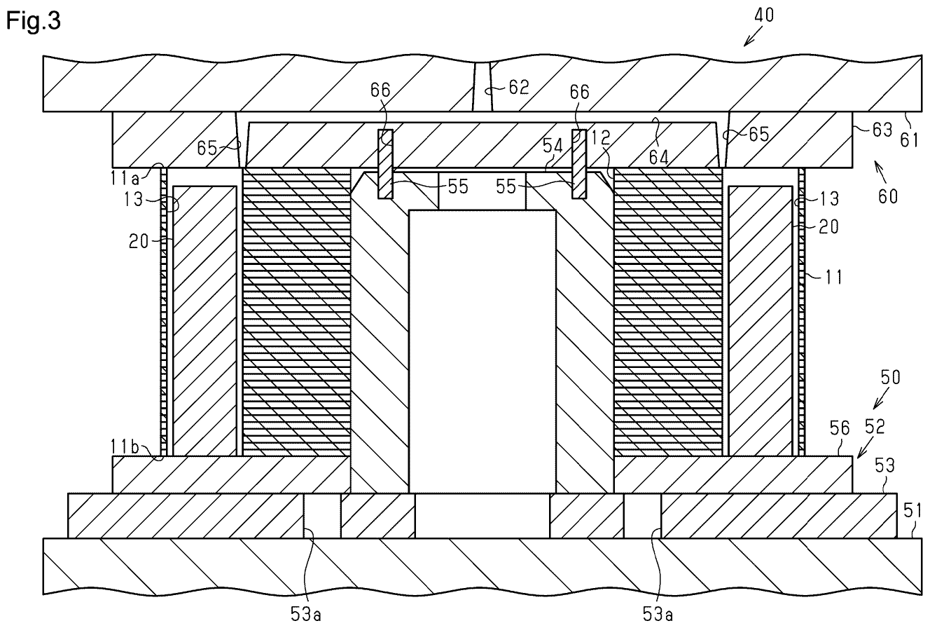

As shown in FIG. 3, the mold device 40 includes a first die 50 and a second die 60.

### First Die 50

The first die 50 includes a first die body 51 and a pallet 52.

The first die body 51 includes a support surface that supports a lower surface of the pallet 52.

The pallet 52 is conveyed between the first die body 51 and the second die 60 in a state in which the pallet 52 supports the rotor core 11.

The pallet 52 includes a base plate 53, a post 54, and a spacer 56. The post 54 projects from a central part of the base plate 53. The spacer 56 is arranged on an upper surface of the base plate 53. The post 54 extends through the spacer 56.

The base plate 53 and the spacer 56 each have the form of a flat plate. The post 54 is cylindrical.

The base plate 53 includes through holes 53a arranged in a radially outer portion of the post 54. The through holes 53a are spaced apart from one another in the circumferential direction. The through holes 53a are covered by the spacer 56.

The post 54 is inserted into the center hole 12 of the rotor core 11. Engagement pins 55 are arranged on the projected end of the post 54. The engagement pins 55 are spaced apart from one another in the circumferential direction.

The spacer 56 supports the second end face 11b of the rotor core 11 into which the post 54 is inserted.

### Second Die 60

The second die 60 includes a second die body 61 and a gate plate 63. For example, the second die body 61 is formed separately from the gate plate 63.

The second die body 61 is, for example, movable toward and away from the first die body 51. The second die body 61 includes a sprue 62 through which the resin material 30 injected from an injection device (not shown) flows.

The gate plate 63 is arranged between the second die body 61 and the rotor core 11. The gate plate 63 includes a runner 64 and gates 65. The runner 64 is connected to the sprue 62. The gates 65 extend from the runner 64.

The runner 64 is open in an upper surface of the gate plate 63. The runner 64 radially extends from a central part of the gate plate 63 in the radial direction. The gates 65 are open in a lower surface of the gate plate 63. The gates 65 connect an end portion of the runner 64 and the magnet housing holes 13.

Engagement holes 66 are arranged in the lower surface of the gate plate 63. The engagement holes 66 engage with the engagement pins 55 of the post 54. The engagement of the engagement pins 55 and the engagement holes 66 positions the gate plate 63 relative to the pallet 52.

### Method for Manufacturing Rotor 10

The method for manufacturing the rotor 10 includes a magnet accommodating step, a die clamping step, and a magnet fixing step. The magnet accommodating step, the die clamping step, and the magnet fixing step are performed in this order.

### Magnet Accommodating Step

As shown in FIG. 3, in the magnet accommodating step, the magnets 20 are accommodated in the magnet housing holes 13 of the rotor core 11, which is supported by the pallet 52. In this case, the lower surface of each magnet 20 is in contact with the upper surface of the spacer 56.

In the magnet accommodating step, the magnets 20 at a normal temperature are accommodated in the magnet housing holes 13. In this specification, a normal temperature refers to 20° C.±15° C.

### Die Clamping Step

In the die clamping step, first, the pallet 52, which supports the rotor core 11, is set on the supporting surface of the first die body 51. Then, the gate plate 63 is mounted on the first end face 11a of the rotor core 11. Accordingly, the first end face 11a of the rotor core 11 is entirely covered by the gate plate 63. Subsequently, the first die 50 and the second die 60 are clamped such that the rotor core 11 is held by the mold device 40 from opposite sides in the axial direction. The first die 50 and the second die 60 are clamped in a state in which the lower surfaces of the magnets 20 accommodated in the magnet housing holes 13 are supported by the spacer 56 of the first die 50.

### Magnet Fixing Step

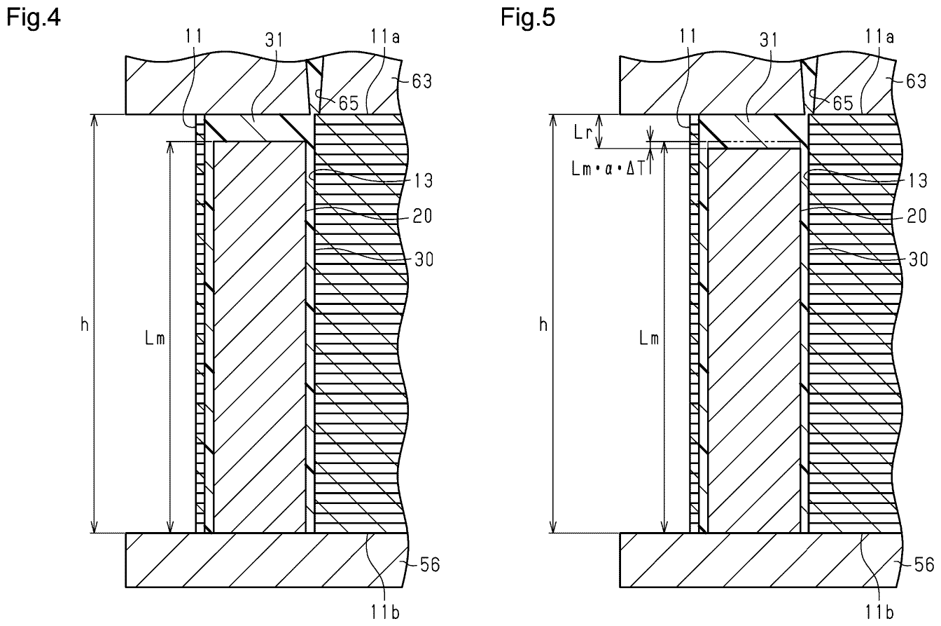

As shown in FIG. 4, in the magnet fixing step, first, an injection device (not shown) fills the magnet housing holes 13, in which the magnets 20 are accommodated, with the resin material 30. The magnet fixing step fills the magnet housing holes 13 with the resin material 30, which has been heated to a predetermined temperature and melted, through the gates 65. In this case, the resin material 30 is injected into the magnet housing holes 13 without any gap between the upper surface of each magnet 20 and the lower surface of the gate plate 63.

When the magnet housing holes 13 are filled with the resin material 30, the heat of the resin material 30 heats the magnets 20. Thus, as shown in FIG. 5, the length of the magnet 20 in the axial direction (hereinafter, simply referred to as the length of the magnet 20) is decreased. In this case, since the lower surface of each magnet 20 is in contact with the upper surface of the spacer 56, the position of the lower surface of the magnet 20 does not change. On the other hand, as indicated by the double-dashed lines shown in FIG. 5, the position of the upper surface of the magnet 20 moves downward.

The amount of deformation of the magnet 20 in the axial direction when the length of the magnet 20 decreases in accordance with the increase in the temperature of the magnet 20 may be expressed as “Lm a ΔT”. The “Lm” represents the length of each magnet 20 in the axial direction before the magnet housing holes 13 are filled with the resin material 30. The “α” represents the negative coefficient of linear expansion of the magnet 20 in the axial direction. The “ΔT” represents an amount of temperature change in the magnet 20. In this case, the temperature change amount ΔT corresponds to a difference between the temperature of each magnet 20 immediately before the magnet housing holes 13 are filled with the resin material 30 and the temperature of the magnet 20 heated by the resin material 30. Since the magnets 20 are at a normal temperature immediately before the magnet housing holes 13 are filled with the resin material 30, “Lm” may also be referred to as the length of the magnet 20 when the magnet 20 is at a normal temperature.

When the length of the magnet 20 decreases, a region of the magnet housing hole 13 above the upper surface of the magnet 20 increases. As the magnet 20 becomes shorter, more resin material 30 flows into the magnet housing hole 13 so as to fill the above region.

When the resin material 30 arranged in the magnet housing holes 13 is cooled, the resin material 30 solidifies inside the magnet housing holes 13. The solidification of the resin material 30 fixes the magnets 20 to the rotor core 11.

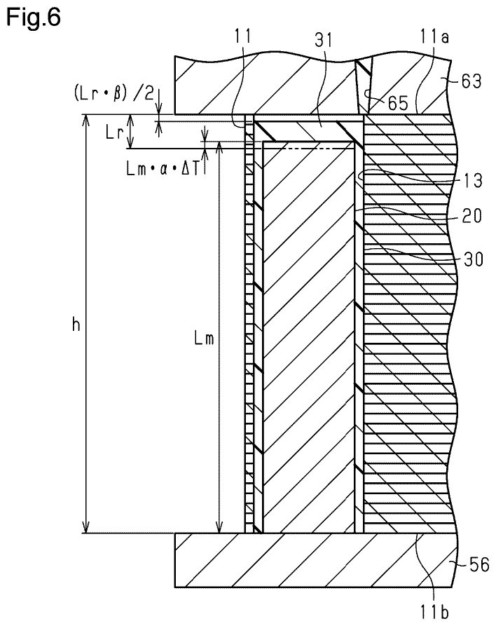

As shown in FIG. 6, when the resin material 30 solidifies, the temperature of the resin material 30 decreases, thereby causing the resin material 30 to contract. This decreases the length of the closing portion 31 in the axial direction (hereinafter, simply referred to as the length of the closing portion 31). The closing portion 31 contracts at two opposite sides in the axial direction. In this case, the upper surface of the closing portion 31 moves downward, and the lower surface of the closing portion 31 moves upward. For example, the amount of deformation of the closing portion 31 in the axial direction is the same at the two sides.

The deformation amount of the closing portion 31 in the axial direction when the resin material 30 contracts may be expressed as “Lr·β”. Accordingly, the deformation amount of the closing portion 31 in the axial direction at one side may be expressed as “(Lr·β)/2”. The “Lr” represents the length of the closing portion 31 in the axial direction when the magnet 20 is heated by the resin material 30 arranged in the magnet housing hole 13 and the length of the magnet 20 is decreased. The “β” represents a contraction rate of the resin material 30. The “Lr” may also be referred to as the length of the closing portion 31 in the axial direction when the length of the magnet 20 is “Lm−(Lm·α·ΔT)”.

In the magnet fixing step, the temperature of the magnet 20 decreases in accordance with the decrease in the temperature of the resin material 30. Thus, length of the magnet 20 is increased. In this case, since the lower surface of each magnet 20 is in contact with the upper surface of the spacer 56, the position of the lower surface of the magnet 20 does not change. On the other hand, as shown by the double-dashed lines shown in FIG. 6, the position of the upper surface of the magnet 20 moves upward. As a result, the length of the magnet 20 returns to the length Lm before the magnet 20 was heated.

The deformation amount of the magnet 20 in the axial direction when the length of the magnet 20 increases in accordance with the decrease in the temperature of the magnet 20 may be expressed as “Lm·α·ΔT”. In this case, the temperature change amount ΔT corresponds to a difference between the temperature of the magnet 20 heated by the resin material 30 and the temperature of the magnet 20 when the magnet 20 is cooled. The temperature change amount ΔT when the magnet 20 is heated by the resin material 30 is equal to the temperature change amount ΔT when the magnet 20 is cooled. Thus, the length of the magnet 20 returns to the length Lm before the magnet 20 was heated.

When the length of the magnet 20 changes in accordance with changes in the temperature of the magnet 20, a length of the magnet 20 in the long-side direction of the magnet 20, which is a non-magnetization direction, also changes. Further, the resin material 30 contracts between the inner walls of the magnet housing hole 13 and the outer surfaces of the magnet 20 forming the short sides. However, the resin material 30 is firmly bound to the outer surfaces of the magnet 20 and the inner walls of the magnet housing hole 13. Thus, a gap is unlikely to be formed between the resin material 30 and the outer surfaces of the magnet 20 and between the resin material 30 and the inner walls of the magnet housing hole 13. The drawings do not show such changes in the dimension of the magnet 20 and the dimension of the resin material 30 in the long-side direction of the magnet 20.

In the present embodiment, the rotor 10 is manufactured so that the deformation amount of the magnet 20 in the axial direction when the length of the magnet 20 increases in accordance with the increase in the temperature of the magnet 20 is greater than or equal to the deformation amount of the closing portion 31 in the axial direction at one side when the resin material 30 contracts. Specifically, in the rotor 10 of the present embodiment, the length Lm of the magnet 20 and the length Lr of the closing portion 31 are set to satisfy an inequality “Lm·α·ΔT≥(Lr·β)/2”. If a relationship between the length Lm of the magnet 20 and the length Lr of the closing portion 31 satisfies an inequality “Lm·α·ΔT<(Lr·β)/2”, a gap will be formed between the magnet 20 and the closing portion 31.

The length Lr of the closing portion 31 may be expressed as “Lr=h−(Lm−Lm·α·ΔT)” in which “h” represents the height h of the rotor core 11 in the axial direction. Thus, in the rotor 10 of the present embodiment, it can also be said that the length Lm of the magnet 20 and the height h of the rotor core 11 are set to satisfy an inequality “Lm·α·ΔT≥{h−(Lm−Lm·α·ΔT)}·β/2”.

The operation and advantages of the present embodiment will now be described.

When the heat of the resin material 30 arranged in the magnet housing hole 13 increases the temperature of the magnet 20, the length of the magnet 20 becomes less than the length Lm. In this case, the deformation amount of the magnet 20 in the axial direction is “Lm·α·ΔT”. Subsequently, the temperature of the magnet 20 decreases as the resin material 30 is cooled such that the length of the magnet 20 increases. In this case, the deformation amount of the magnet 20 in the axial direction is “Lm·α·ΔT”. Thus, the length of the magnet 20 returns to the original length Lm.

When the resin material 30 is cooled, the resin material 30 contracts and the length of the closing portion 31 becomes less than the length Lr. In this case, the deformation amount of the closing portion 31 in the axial direction is “Lr·β”. The resin material 30 contracts uniformly at the two sides in the axial direction. Thus, the closing portion 31 moves away from the magnet 20 by the distance “(Lr·β)/2”.

In the method for manufacturing the rotor 10 of the present embodiment, the length Lm of the magnet 20 and the length Lr of the closing portion 31 are set to satisfy “Lm·α·ΔT≥(Lr·β)/2”. Therefore, when the resin material 30 is cooled, the deformation amount of the magnet 20 when the length of the magnet 20 is increased becomes greater than or equal to the deformation amount of the closing portion 31 in the axial direction at one side when the length of the closing portion 31 is decreased. As a result, a gap will not be formed between the magnet 20 and the closing portion 31. This avoids reduction in the magnetic strength of the magnet 20.

### Modified Examples

The present embodiment may be modified as described below. The present embodiment and the following modifications can be combined as long as the combined modifications remain technically consistent with each other.

The magnet 20 may be a magnet other than a neodymium magnet as long as the magnet 20 has a negative coefficient of linear expansion in a non-magnetization direction.

The resin material 30 is not limited to a liquid crystal polymer and may be, for example, polyphenylene sulfide (PPS), polyether ether ketone (PEEK), polyamide (PA), or the like.

In the magnet accommodating step, for example, a support pin may be arranged on the spacer 56 to support the lower surface of each magnet 20 so that the lower surface of the magnet 20 is located at an inner side of the second end face 11b of the rotor core 11 in the axial direction. In this case, in the magnet fixing step, the resin material 30 solidifies in a state in which the lower surface of the magnet 20 is located at the inner side of the second end face 11b of the rotor core 11 in the axial direction. Such a method also has the same advantages as the above embodiment.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A method for manufacturing a rotor,
the rotor including a cylindrical rotor core that includes a magnet housing hole, a magnet accommodated in the magnet housing hole, and a thermoplastic resin material that fills the magnet housing hole and fixes the magnet to the rotor core;
the magnet having a negative coefficient of linear expansion in a non-magnetization direction orthogonal to a magnetization direction, the magnet being oriented and accommodated in the magnet housing hole such that the non-magnetization direction coincides with an axial direction of the rotor core; and
the resin material including a closing portion that covers one end surface of the magnet in the axial direction inside the magnet housing hole and closes an opening of the magnet housing hole, the method comprising:
holding the rotor core from opposite sides in the axial direction with a die, the die being configured to inject the resin material into the magnet housing hole, in a state in which the die supports an other end surface of the magnet accommodated in the magnet housing hole, the other end surface being opposite to the one end surface; and
fixing the magnet to the rotor core by filling the magnet housing hole, in which the magnet is accommodated, with the resin material that is melted and solidifying the molten resin material,
wherein, when a length of the magnet in the axial direction before the resin material is injected into the magnet housing hole is represented by Lm, a length of the closing portion in the axial direction when the magnet is heated by the resin material arranged in the magnet housing hole and the length of the magnet is decreased is represented by Lr, the negative coefficient of linear expansion of the magnet in the axial direction is represented by α, a contraction rate of the resin material is represented by β, and a difference between a temperature of the magnet when the magnet is heated by the resin material arranged in the magnet housing hole and the length of the magnet is decreased and a temperature of the magnet when the resin material is cooled and solidified is represented by ΔT,
the length Lm of the magnet and the length Lr of the closing portion are set to satisfy an inequality Lm·α·ΔT≥(Lr·β)/2.
